(19) United States
(12) Patent Application Publication
(10) Pub. No.: US 2015/0035290 A1
(43) Pub. Date: Feb. 5, 2015

(54) APPARATUS AND METHODS FOR CONSTRAINING REVERSE MOTION OF A TRANSLATING MEMBER

(71) Applicant: SURELOCK McGILL LIMITED, Wokingham (GB)

(72) Inventors: John McGILL, Berkshire (GB); Andrew Allan STAINES, Yateley (GB); Stuart Kenneth PARKER, Portsmouth (GB)

(21) Appl. No.: 14/286,958

(22) Filed: May 23, 2014

(30) Foreign Application Priority Data
Aug. 2, 2013 (GB) 1313858.1

(51) Int. Cl. E05C 1/08

(52) U.S. Cl. CPC E05C 1/08
USPC 292/163; 292/137

(57) ABSTRACT

A member, for example a bolt of a bolting mechanism, has a direction of translation. A plurality of blades are arranged to slide progressively across an arrest of the member, in a direction transverse to the simultaneous movement of the member in the direction of translation, to thereby prevent reverse movement of the member over a continuous range of member positions. In particular, each blade prevents return movement over a different range of member positions than the other blades.

The present invention relates to apparatus and methods for constraining reverse motion of a translating member. For example, the invention may be used to hold a bolt in an engaged or retracted position, where the precise position of engagement or retraction may vary, until release is required.

### INTRODUCTION

It is known to constrain a member moved in a translation direction, such as a bolt or rod, from moving in a reverse direction until released to do so. Example applications of this general principle are provided in GB2423787 in which a mechanism is used to retain a bolt in a retracted position, preventing reverse movement until a door to be bolted is closed, and GB2338507 in which a restraint mechanism is used to prevent forced unlocking of bolts.

It would be desirable to provide an improved mechanism to allow a member to move in a direction of translation, while progressively and continuously preventing reverse motion over a range of movement of the member, until the mechanism is released.

### SUMMARY OF THE INVENTION

Accordingly, the invention provides a member having a direction of translation and at least one arrest, and a plurality of blades. Each blade is arranged to engage, move, or slide progressively across or along the arrest of the member in a direction transverse to simultaneous progressive movement of the member in the direction of translation, and to thereby prevent reverse movement of the member over a continuous range of positions of the member corresponding to the sliding range of movement of the blade.

The apparatus is also arranged such that each blade slides progressively across the arrest, to prevent return movement of the member, over a different range of member position than the corresponding range of member position controlled by each of the one or more other blades, although these different ranges of member position may overlap.

The transverse motion may be substantially perpendicular to the direction of translation of the member, although more oblique angles could be used. The invention enables the member to move in the translation direction, with reverse movement being prevented by the claimed mechanism regardless of the position of the member within a continuous range of movement over which the blades prevent return movement. The range can be extended for example by providing a larger number of blades, although the mechanism can work with 2, 3, 4 or more blades. Typically, each blade is independently biased towards engagement with the arrest. More than one blade may engage with the arrest at the same time, although significant overlap in this way will tend to reduce the overall range of the non-return action. To this end, the mechanism can be arranged so that each blade engages with the arrest to provide non-return action over a different range of member positions, or over ranges of positions with only a small overlap such as less than a 10% overlap.

Each blade may comprise a latch surface arranged to slide progressively across a corresponding strike surface of the arrest, wherein at least one of each latch portion and the corresponding strike portion comprises an oblique surface arranged to slide across the other of the latch portion and corresponding strike portion. The oblique surfaces are open in the sense that urging a blade towards an arrest leads to the desired sliding action as the member moves in the direction of translation. If both of each latch portion and the corresponding strike portion comprises an oblique strike surface, the oblique surfaces may be substantially parallel to each other so that they abut face-to-face when in contact, and provide increased friction against reverse motion of the member urging the blade away from the arrest.

To optimise a balance between maximising the range of non-return action and maximising the strength of the non-return action for a particular blade, the angle of the oblique surfaces to the direction of translation of the member may from 65 to 80 degrees, or more particularly from 70 to 75 degrees.

So that the ranges of non-return action provided by the plurality of blades provide an extended range of non return action, either the strike portions of the or each arrest, or the latch portions of the blades, or optionally both of these, may be staggered along the direction of translation of the member such that each blade constrains the member over a different range of positions than the one or more other blades.

The blades may be provided by a plurality of stacked plates, each stacked plate being arranged to slide in a direction transverse to the direction of translation of the member independently of the other stacked plates. The blades may be formed in other ways, for example using rods or other components. The plurality of blades may be biased towards the member by a plurality of corresponding leaf springs, each such leaf spring biasing a corresponding one of the blades towards the member.

To further extend the range of progressive non-return action, the member may comprise a plurality of arrests arranged such that each arrest enables the blades to prevent reverse movement of the member over a different range of positions than the other arrest or arrests. So that the blades can progress from one arrest to another as the member moves in the direction of translation, each blade may comprise a ratchet face arranged such that the member drives the blade away from the member when the member is translated further in the direction of translation, to thereby enable the blades to engage with any of the arrests.

The or each arrest may be provided by a notch in the member; a shoulder on the member, a protrusion from the member, and/or in other ways.

The apparatus may comprise a withdrawal mechanism arranged to retract the blades (or those blades which are extended) to thereby allow release and unrestricted reverse movement of the member.

The invention may also provide a bolting mechanism adapted to secure a leaf within a frame, for example a leaf hinged on the frame, using at least one bolt which secures the leaf within the frame when in an extended position, comprising the apparatus of any preceding claim arranged to prevent retraction of the bolt through reverse movement when in an extended position, or to prevent extension of the bolt through reverse movement when in a retracted position. The invention may therefore also provide a leaf within a frame comprising such a bolting mechanism.

The invention also provides apparatus comprising: a plurality of biased members each arranged to move independently of the other biased members (for example the blades discussed above); and a leaf spring array, which may be provided by an integral leaf spring array component which comprises a plurality of leaf springs joined together (for example comprising the leaf springs discussed above), the leaf spring array or integral leaf spring array component being arranged such that each leaf spring biases the movement of a different one of the plurality of the biased members.

Each biased member may be arranged to move progressively, and independently of the other biased members, into closer engagement with a further member, for example the translating member discussed above, under influence of the bias, to thereby restrict movement of the further member. The further member or translating member may comprise a bolt, for example of a bolting mechanism, and each biased member may then be arranged to slide progressively into closer engagement with the further member in a direction transverse to simultaneous movement of the further member, to thereby prevent or restrict reverse movement of the further member.

The integral leaf spring array component may comprise said plurality of leaf springs and a tab, each leaf spring having a proximal end for engagement with a respective one of the biased members, and a distal end joined to the other leaf springs by the tab.

The invention also provides methods corresponding to preparation and/or operation of the disclosed apparatus, for example a method of controlling reverse movement of a member having a direction of translation, comprising sequentially sliding each of a plurality of blades progressively across an arrest of the member in a direction transverse to simultaneous movement of the member in the direction of translation, such that each sliding blade engages with the arrest to thereby prevent reverse movement of the member over a range of member positions, and such that each blade prevents reverse movement of the member over a different range of member position than the one or more other blades.

### BRIEF DESCRIPTION OF THE DRAWINGS

Embodiments of the invention will now be described, by way of example only, with reference to the drawings of which:

FIG. 1 illustrates a door securable using a bolting mechanism which could implement aspects of the invention;

FIGS. 2 and 3A to 3D show how a blade may be used to provide a progressive non-return action by sliding transversely against an arrest of a moving member;

FIGS. 4 and 5 show how multiple blades can be used to extend the range of progressive non-return action provided;

FIGS. 6 and 7 are a perspective and plan view of a restraint mechanisms according to the invention using multiple blades in a manner similar to FIG. 4; and

FIG. 8 shows in perspective view an integral leaf spring array component for use in the apparatus, for example to provide the leaf springs shown in FIGS. 6 and 7.

### DETAILED DESCRIPTION OF EMBODIMENTS

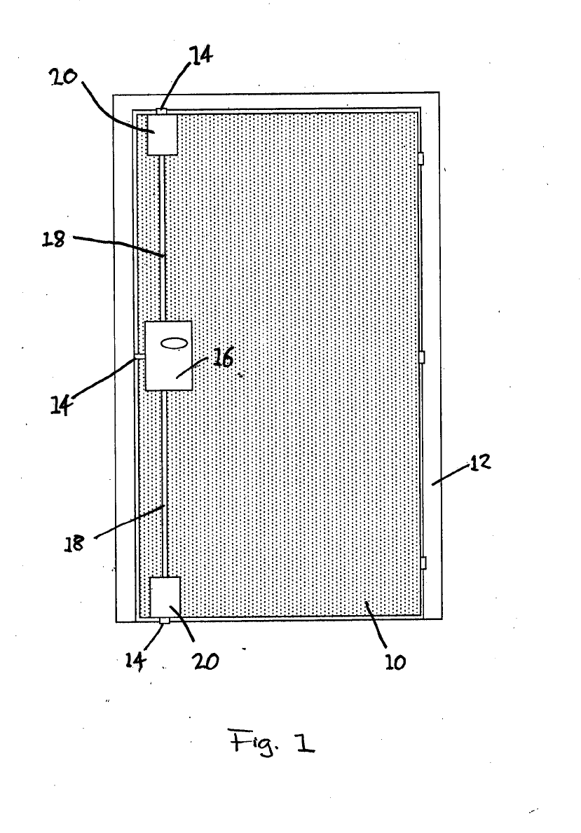

By way of example, one application for the invention is in bolting arrangements to secure a leaf such as a door 10 within a frame 12. In FIG. 1 the door is secured within the frame by bolts 14 which are driven directly by a bolting mechanism 16 and by pushrods 18 connecting the bolting mechanism to those bolts 14 located at the top and bottom of the door at auxiliary units 20. When the bolts have been thrown into an extended position in which the door is secured within the frame, it may be desirable to constrain the bolts in the extended or thrown position, for example until a release mechanism is triggered to allow withdrawal of the bolts. Embodiments of the invention provide apparatus which may be used for constraining the bolts to stay in extended positions, thereby preventing return or reverse movement to the retracted position until released. Similarly, embodiments of the invention may be used to constrain the bolts to stay in retracted positions, thereby preventing return or reverse movement to extended positions until released.

Such apparatus for constraining the bolts of FIG. 1 may implemented within either or both of the bolting mechanism and the auxiliary units, and may act directly on the bolts, on the pushrods, or on other intermediary elements coupled to the bolting action. The precise degree of extension of the bolts when thrown may vary, for example depending on the closing position of the door, its relative position to the frame, movement and slight changes of shape and/or size of the door or frame, and the presence of interfering material such as detritus in the vicinity of the tips of the thrown bolts. Similarly, the precise position of bolts when retracted may vary. Embodiments of the invention provide an arresting, non-return mechanism which can be used to constrain one or more bolts in an extended, or alternatively in a retracted position without requiring precise adjustment or prior knowledge of the precise position of the bolts in that position.

Embodiments of the invention may be used in a variety of other contexts and applications, for example in any context where it is desirable to constrain or prevent the return or reverse motion of an advancing member such as a bolt, push rod or other member. In particular, embodiments may be used to constrain such a member, having moved in a direction of translation, from moving in a reverse direction, in a progressive and continuous manner.

Embodiments of the invention may be better understood from a consideration of FIG. 2. In this figure a member 30 moves towards the left of the figure in a direction of translation 31. This may be by way of a sliding motion. A blade 32 is urged towards the member in a direction 33 transverse to the direction of translation 31 of the member 30, as shown by the upward facing arrow. A shoulder of the member 30 forms an arrest 34, and a latch portion or surface 38 of the blade 32 is arranged to slide or engage along a strike portion or surface 36 of the arrest in the direction 33 as the arrest moves past the blade. At any point at which the member stops moving in the direction of translation 31, return movement of the member in the direction indicated by arrow 35 is blocked by the blade being in engagement with the arrest 34. Typically, the blade and arrest are designed such that bias of the blade towards the arrest and friction between the blade and the arrest prevent a force on the member in the return direction 35 from pushing the blade 32 away from the member. This effect can be achieved, for example, by using an appropriate angle of contact between the blade and the arrest as described further below.

The arrangement of FIG. 2 provides for a small range of movement of the member over which the blade provides a continuous non-return action. The range of this non-return action can be extended as discussed in more detail later in this document.

In the arrangement of FIG. 2 the strike surface 36 of the arrest 34 and the latch surface 38 of the blade 32 are substantially parallel so as to provide a face to face or confrontational sliding engagement between the two surfaces, and these surfaces are oblique to the axis of translation of the member so that the blade slides transversely to the movement of the member to provide the continuous non-return action. The angle of each face to the axis of movement of the member may preferably be in the range of about 65 to 80 degrees, or more preferably in the range of 70 to 75 degrees, in order to prevent a return force on the member from displacing the blade. However, these angles may be varied as required depending on the materials of the blade and arrest, the construction of the apparatus, and the mechanism within which the arrangement is implemented.

Also in FIG. 2 the arrest is provided by a shoulder defining one side of a notch in the member, but other structures may be used for the arrest.

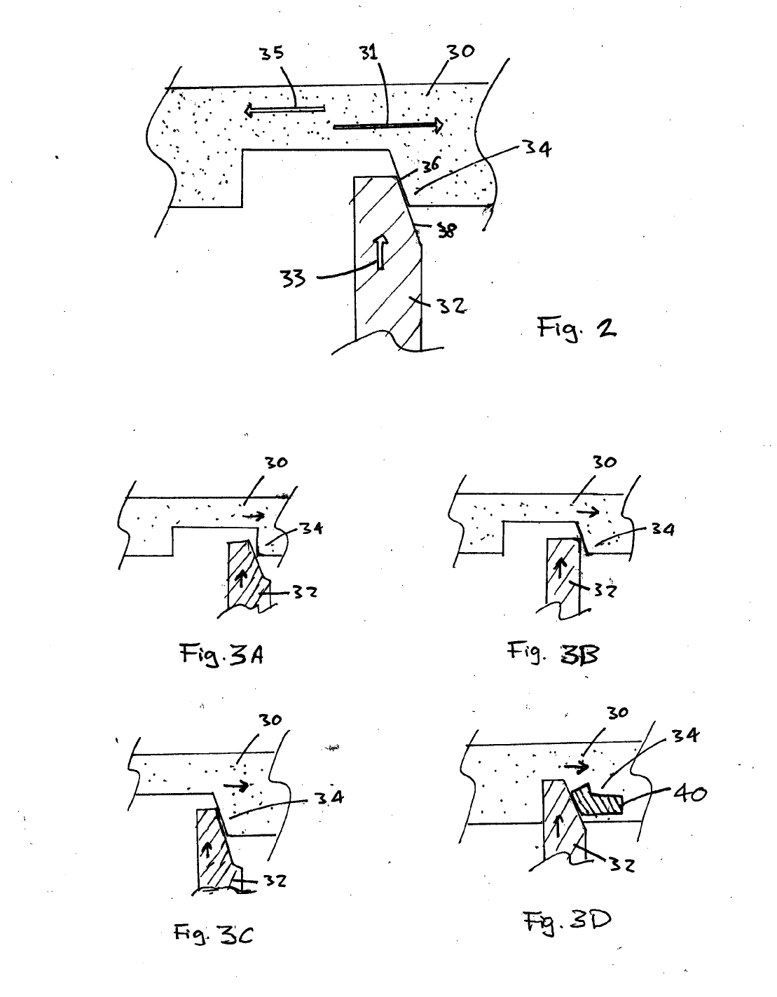

FIGS. 3A to 3D illustrate other ways in which the member 30, blade 32 and arrest 34 may be implemented. For example, in FIG. 3A only the latch surface of the blade is oblique, and the strike surface of the arrest is provided by another form such as a corner of rounded surface. In FIG. 3B the strike surface of the arrest is provided by an oblique surface, and the latch surface of the blade is provided by a corner or rounded surface. In FIG. 3C the arrest is provided by a shoulder of the member, but this does not form part of a notch in the member. In FIG. 3D the arrest 34 is formed by a protrusion 40 from the member.

Note that the transverse motion of the blade can be provided in various ways, for example by a linear or translation motion, or by a rotational motion about a pivot spaced from the latch surface along the direction of motion of the member, so as to provide an essentially linear motion of the latch surface transverse to the direction of translation of the member. Similarly, although the transverse motion of the blade may be in a direction perpendicular to the direction of translation of the member, this need not necessarily be so, with more oblique angles between the motions being possible.

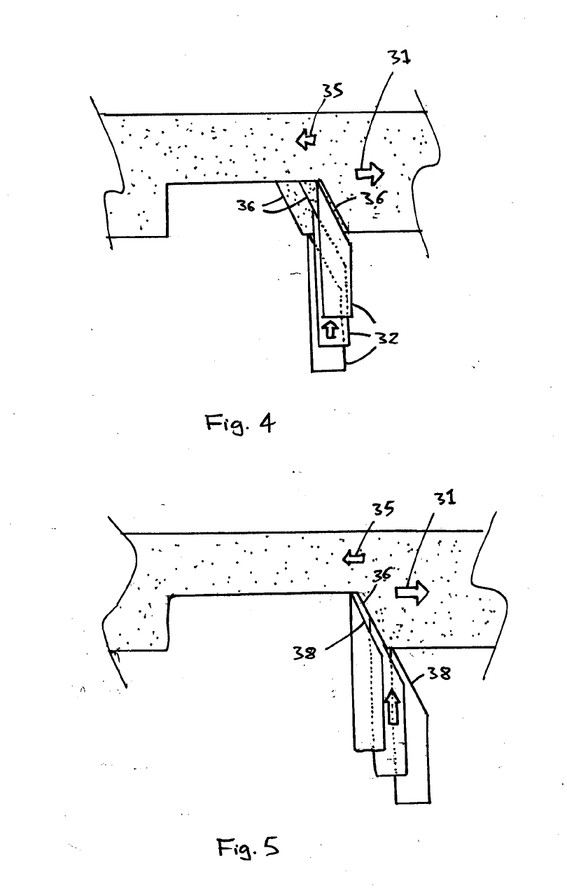

FIGS. 4 and 5 illustrate how a plurality of blades as discussed above can be provided in embodiments of the invention to provide an extended range of continuous non-return action against the member. Each blade is arranged to engage the arrest, to prevent return movement of the member, over a different range of member positions than the one or more other blades. Typically, each blade is independently urged towards the member. The ranges of non-return motion provided by the blades may overlap with each other to some extent if desired, or may touch without overlapping to provide the maximum combined range.

In FIG. 4 the arrest 34 comprises a plurality of strike surfaces 36, each strike surface being arranged to engage with a different blade 32. The strike surfaces are staggered along the direction of translation of the member. Although in FIG. 4 the blades are shown stacked but slightly offset from each other for the purposes of clarity, the blades may be stacked directly on top of each other. The strike surfaces 36 are formed in the arrest 34 at depths corresponding to the stacked blades.

Starting with all the blades retracted away from the member, as the member slides in the direction of translation 31, first the top blade slides along the arrest towards the member, then each of the other blades follow in turn although to improve continuity there may be some overlap of the sliding action of each blade. Each blade engages with the arrest over a different range of member positions, and engages in a continuous manner over that range to prevent return movement of the member irrespective of where in the overall range the member is located when a force in the reverse direction 35 is applied.

FIG. 5 shows an alternative arrangement in which the strike surfaces 36 of the arrest 34 are not staggered, but instead form a single continuous oblique surface of the arrest, and the latch surfaces 38 of the blades 32 are staggered along the direction of translation of the member so that each blade provides the non-return action over a different range of member positions. A combination of the staggering arrangements of FIGS. 4 and 5 is also possible.

It will be seen that by combining the ranges of the non-return action of each of the blades in a suitable way such as shown in FIG. 4 or 5, an extended continuous range of non-return action can be achieved, up to a maximum range which is equivalent to the sum of the individual ranges of each blade if there is no overlap between the ranges. A further extended range of non-return action can be achieved by the provision of a plurality of arrests, such that each blade can move from one arrest to an adjacent arrest, as described in more detail later in this document. In such a case, a mechanism may be required to oblige blades to retract, for example by providing each blade with a ratchet face arranged such that the member drives the blade away from the member when the member is translated further in the direction of translation.

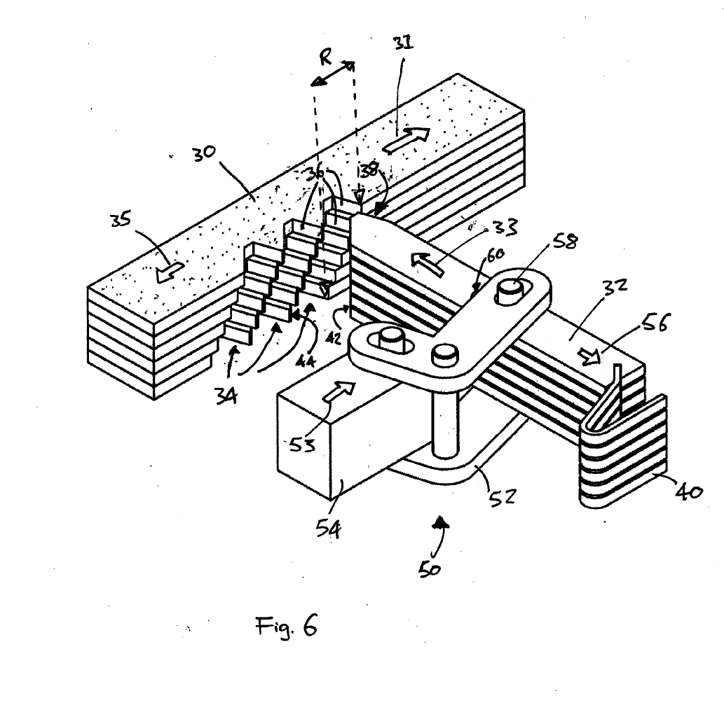

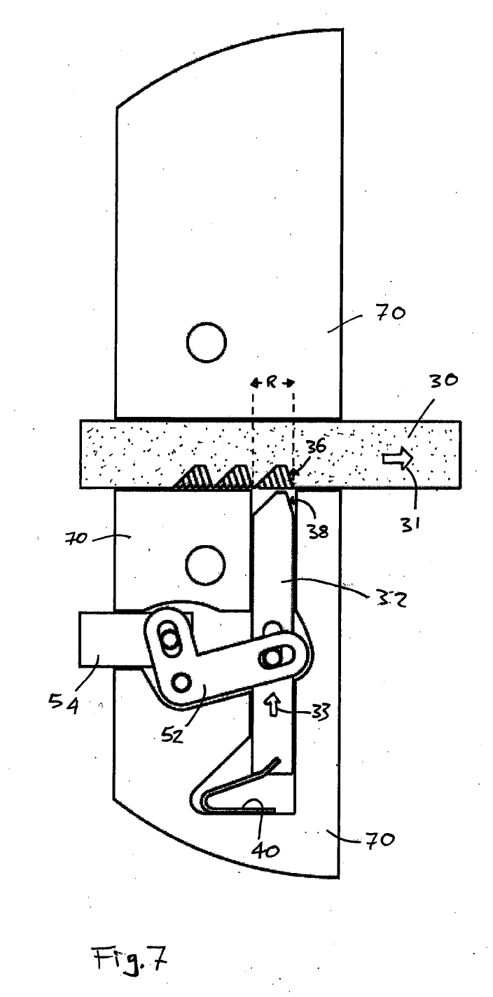

Referring now to FIG. 6 there is illustrated in perspective view an embodiment of the invention implemented using principles discussed above. The skilled person will see that the arrangement of FIG. 6 can be varied in ways for example as already discussed above in respect of the various functional aspects and components.

In particular, FIG. 6 shows a plurality of blades 32. These take the form of stacked and aligned plates which are constrained to slide in the direction indicated by the arrow 33 towards the member 30, or in the reverse direction. The member 30 is constrained to slide in a direction of translation 31, or in a return direction 35, although the constraints which oblige the blades and member to move in these directions are omitted for the purposes of clarity.

Each blade 32 is urged towards the member 30 by a leaf spring 40. The leaf springs are provided as an aligned stack, with each leaf spring arranged to bias a corresponding one of the blades 32 in the direction 33.

The member is provided with a plurality of arrests 34, in this case three such arrests. Each arrest is provided by a shoulder of a notch in the member 30. Each notch shoulder presents a plurality of strike surfaces 36, and each blade presents a latch surface 38 (not visible in this perspective view) such that each strike surface corresponds and is arranged to engage with the latch surface 38 of a corresponding one of the blades 32.

The strike surfaces 36 and the latch surfaces 38 are oblique to both the direction of translation 31 of the member 30 and to the transverse direction of motion 33 of the blades. As discussed above, each pair of oblique strike and latch surfaces are preferably parallel, and a suitable angle of these surfaces with respect to the direction of motion of the member may be about 70 to 75 degrees for the non return action of the mechanism to be secure while allowing each blade to also provide non-return action over a reasonable range of movement of the member 30.

In operation, the member 30 initially adopts a position in which the blades press upon a region of the member 30 to the right of the arrests 34, urged towards the member 30 by the leaf springs 40. As the member moves in the direction of translation 31, the uppermost blade 32 is the first to engage with the first arrest. During this engagement process the latch surface 38 of the uppermost blade comes into sliding contact with the corresponding right most strike surface 36, and as the member 30 moves in the direction of translation 31 the uppermost blade slides towards the member 30 until it is fully engaged and can slide no further. Continued movement of the member 30 in the direction of translation leads to each blade in turn sliding into engagement with the member in the same way.

During this process, if the member 30 stops moving in the direction of translation 31 and is urged in the opposite, return direction 35, the engagement of at least one of the blades with the member prevents the return motion. The blades and arrests are arranged such that the plurality of blades provide for an extended range of movement (labelled as “R” in the figure) of the member 30 over which the blades, in combination, provide a continuous and progressive non-return action.

Note that in FIG. 6, when a blade has moved towards the member to the fullest extent, a ratchet face 42 on the blade (not visible in this perspective view) engages with a corresponding ratchet face 44 on the member (also visible in this perspective view) to drive the blade out of engagement with the member as the member continues to progress in the direction of translation 31. Once driven out of engagement, each blade can then be used in combination with the subsequent arrests 34 to provide a non-return action over a second range of movement of the member 30. In FIG. 3, the three arrests 34 provide for approximately three times the range of non-return action than would be provided by the blades and a single arrest.

Typically, it will be desirable to release the non-return action provided by the blades at some point in time, to enable the member 30 to move in the reverse direction 35. To this end a withdrawal mechanism 50 is provided to retract any and all of the blades which are engaged with the member 30 to thereby release the non-return action. The withdrawal mechanism 50 may take a variety of forms, but in the arrangement of FIG. 6 it is provided by a pivoted coupling 52 which translates movement 53 of a driving rod 54 into a driving movement at the blades 32 in the reverse direction 56 to effect the retraction. The pivoted coupling 52 is coupled to the blades 32 by means of a pin 58 passing through a slot 60 in each of the blades. The slot 60 permits each of the blades to move independently into engagement with the arrest 34 despite the pin passing 58 passing through all of the blades, while permitting the pin to retract any engaged blades by urging the blades against the action of the leaf springs 40.

FIG. 7 shows the arrangement of FIG. 6 in plan view, and also illustrates how material or structure of a casing 70 could be used to constrain the member 30, the blades 32, and other components as necessary to move in the desired directions.

The blades 32 and member 30 may typically be made of a suitable steel, although other metals, plastics, and other materials may be used if appropriate. To achieve the staggering of the strike surfaces 36 in each arrest 34 of the arrangement of FIGS. 4 and 6 a member formed of laminated sheets may be used, with each laminated sheet providing the strike surface(s) for one of the blades. Although components and structures of various dimensions may be used, in one embodiment according to FIG. 6 each strike surface 36 provides a range of non-return action of about 1.5 mm, so that each arrest provides a total range of non-return action of about 9.0 mm using six strike surfaces and six blades. The provision of three arrests 34 in the member 30 allows for a total non-return action of about 27.0 mm, or a little less than this if a small amount of overlap between the ranges provided by each adjacent blade and/or the ranges provided by each arrest.

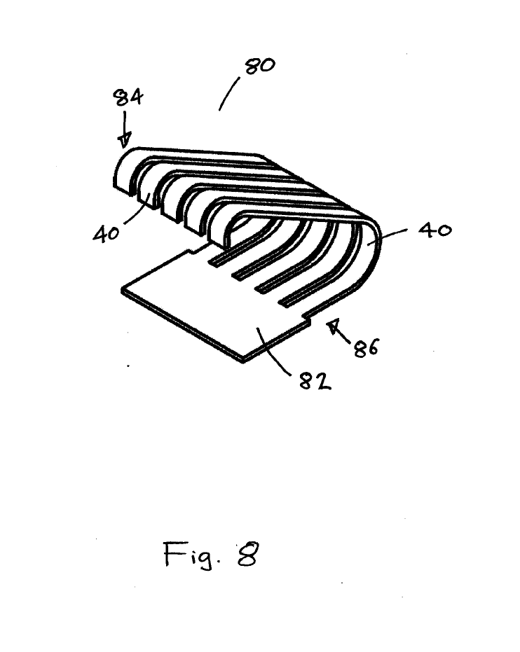

In the arrangement of FIGS. 6 and 7, each blade 32 is urged towards the member 30 by a leaf spring 40. The leaf springs are provided as an aligned stack, with each leaf spring arranged to bias a corresponding one of the blades 32 in the direction 33. In some embodiments, for example as illustrated in FIG. 8, this array of leaf springs 40 may be provided as an integral leaf spring array component 80 with a tab 82 or back which joins the leaf springs 40 to form a comb structure. The tab 82 may be rectangular or of some other shape, and typically the leaf springs 40 in combination with the tab 82 may be formed together of a suitable shaped plate of material.

Each leaf spring 40 has a distal end 84 which is used to apply a force of the leaf spring to the member to be biased, and a proximal end 86 at which the leaf springs 40 are joined together by the tab. The leaf springs may be curved or bent out of the plane of the tab (for example when in an unforced state), and in a particular may all have the same curve shape, and the tab may be flat or substantially flat.

The integral leaf spring array component 80 is formed of a single piece or plate of material. The material may typically, but not necessarily, be a metal such as a spring steel, and could for example be formed by punching the tab and leaf spring elements as a single element from a suitable piece or plate of the material. The leaf spring elements could then be bent into the desired configurations using known techniques, for example by pressing around a suitable former component and providing a heat treatment.

Using an integral leaf spring array component 80 of this type, the leaf springs 40 of FIGS. 6 and 7 can be conveniently provided and combined into the apparatus without having to separately handle the individual leaf springs, and without having to make any careful alignments of the separate leaf springs 40. A leaf spring mounting structure of the apparatus, to which or within which the leaf springs 40 are mounted in the correct configuration to suitably bias the blades 32 may also be simplified.

The integral leaf spring array component 80 discussed above may also be used in other apparatus, for example in any apparatus to independently bias the movement of a plurality of adjacent elements or members which are arranged to move independently in some way. These adjacent elements could be parallel elements such as the blades 32 of FIGS. 2 to 7, or could be other adjacent and/or parallel elements arranged for translational and/or rotational and/or other movement.

Various modifications may be made to the described embodiments without departing from the scope of the invention. For example, although FIG. 6 generally depicts blades provided in the form of stacked plates, other shapes, cross sections and structures may be used for the blades to achieve the required effect. Similarly, although the blades of FIGS. 6 and 7 are depicted generally as moving through translation, a rotational movement may be used, for example about a pivot displaced from the arrests along the direction of translation of the member 30. Although the term “blades” has been used herein, other terms could be used to describe the same components, such as “members” or “detainers”. Although the blades are sometimes described above as sliding, they could instead be described as engaging, moving or translating, for example across or relative to the arrest.

1. Apparatus comprising:
a member having a direction of translation and at least one arrest; and
a plurality of blades, each blade being arranged to slide progressively across the arrest in a direction transverse to simultaneous progressive movement of the member in the direction of translation, to thereby prevent reverse movement of the member over a range of member positions,
the apparatus being arranged such that each blade slides progressively across the arrest, to prevent return movement of the member, over a different range of member position than the one or more other blades.

2. The apparatus of claim 1 arranged such that the plurality of blades in combination with the arrest prevent return movement of the member over a continuous range of member positions.

3. The apparatus of claim 1 wherein each blade is independently biased towards engagement with the arrest.

4. The apparatus of claim 1 wherein each blade comprises a latch portion arranged to slide progressively across a corresponding strike portion of the arrest, wherein at least one of each latch portion and the corresponding strike portion comprises an oblique surface arranged to slide across the other of the latch portion and corresponding strike portion.

5. The apparatus of claim 4 wherein both of each latch portion and the corresponding strike portion comprise an oblique strike surface, the oblique surfaces being substantially parallel to each other.

6. The apparatus of claim 4 wherein the angle of the oblique surfaces to the direction of translation of the member is from 65 to 80 degrees.

7. The apparatus of claim 4 wherein at least one of the following are staggered along the direction of translation of the member such that each blade constrains the member over a different range of positions than the one or more other blades: the strike portions of the or each arrest, and the latch portions of the blades.

8. The apparatus of claim 1 wherein the blades are provided by a plurality of stacked plates, at least the latch portion of each stacked plate being arranged to slide in a direction transverse to the direction of translation of the member independently of the other stacked plates.

9. The apparatus of claim 1 wherein the plurality of blades are biased towards the member by a plurality of corresponding stacked leaf springs, each such leaf spring biasing a corresponding one of the blades towards the member.

10. The apparatus of claim 9 wherein the plurality of corresponding stacked leaf springs are provided by an integral leaf spring array component formed of a single piece of material, the integral leaf spring array component comprising the leaf springs and a tab joining the leaf springs together.

11. The apparatus of claim 1 wherein the member comprises a plurality of said arrests arranged such that each arrest enables the blades to prevent reverse movement of the member over a different range of positions than the other arrest or arrests.

12. The apparatus of claim 11 wherein each blade comprises a ratchet face arranged such that the member drives the blade away from the member when the member is translated further in the direction of translation, to thereby enable the blades to engage with any of the arrests.

13. The apparatus of claim 1 wherein the or each arrest is provided by at least one of: a notch in the member; a shoulder on the member; and a protrusion from the member.

14. The apparatus of claim 1 comprising a withdrawal mechanism arranged to retract the blades to thereby allow reverse movement of the member.

15. A bolting mechanism adapted to secure a leaf within a frame using at least one bolt which secures the leaf within the frame when in an extended position, comprising an apparatus comprising:
a member having a direction of translation and at least one arrest; and
a plurality of blades, each blade being arranged to slide progressively across the arrest in a direction transverse to simultaneous progressive movement of the member in the direction of translation, to thereby prevent reverse movement of the member over a range of member positions,
the apparatus being arranged such that each blade slides progressively across the arrest, to prevent return movement of the member, over a different range of member position than the one or more other blades, arranged to prevent retraction of the bolt through reverse movement when in an extended position, or to prevent extension of the bolt through reverse movement when in a retracted position.

16. A leaf within a frame comprising a bolting mechanism adapted to secure a leaf within a frame using at least one bolt which secures the leaf within the frame when in an extended position, comprising an apparatus comprising:
a member having a direction of translation and at least one arrest; and
a plurality of blades, each blade being arranged to slide progressively across the arrest in a direction transverse to simultaneous progressive movement of the member in the direction of translation, to thereby prevent reverse movement of the member over a range of member positions,
the apparatus being arranged such that each blade slides progressively across the arrest, to prevent return movement of the member, over a different range of member position than the one or more other blades, arranged to prevent retraction of the bolt through reverse movement when in an extended position, or to prevent extension of the bolt through reverse movement when in a retracted position.

17. Apparatus comprising:
a plurality of biased members each arranged to move independently of the other biased members; and
an integral leaf spring array component comprising a plurality of leaf springs joined together, the integral leaf spring component being arranged such that each leaf spring biases the independent movement of a different one of the plurality of the biased members.

18. The apparatus of claim 17 wherein each biased member is arranged to move progressively, and independently of the other biased members, into closer engagement with a further member, under influence of the bias, to thereby restrict movement of the further member.

19. The apparatus of claim 17 wherein the further member comprises a bolt, and each biased member is arranged to slide progressively into closer engagement with the further member in a direction transverse to simultaneous movement of the further member, to thereby prevent reverse movement of the further member.

20. The apparatus of claims 17 wherein the integral leaf spring array component comprises said plurality of leaf springs and a tab, each leaf spring having a distal end for engagement with a respective one of the biased members, and a proximal end joined to the other leaf springs by the tab.

21. The apparatus of claim 20 wherein the tab defines a plane, and the leaf springs are shaped to adopt a curve extending out of the plane when unforced.

22. A method of controlling reverse movement of a member having a direction of translation, comprising:
sequentially sliding each of a plurality of blades progressively across an arrest of the member in a direction transverse to simultaneous movement of the member in the direction of translation, such that each sliding blade engages with the arrest to thereby prevent reverse movement of the member over a range of member positions, and such that each blade prevents reverse movement of the member over a different range of member position than the one or more other blades.

23. The method of claim 22 comprising thereby preventing return movement of the member over a continuous range of member positions within which each range of member positions over which the individual blades prevent reverse movement are comprised.

24. The method of claim 22 wherein each blade comprises a latch portion which slides progressively across a corresponding strike portion of the arrest, wherein at least one of each latch portion and the corresponding strike portion comprises an oblique surface which slides across the other of the latch portion and corresponding strike portion.

25. The method of claim 22 wherein at least one of the following are staggered along the direction of translation of the member such that each blade constrains the member over a different range of positions than the one or more other blades: the strike portions of the or each arrest, and the latch portions of the blades.
